(19) United States
(12) Patent Application Publication
(10) Pub. No.: US 2007/0016342 A1
(43) Pub. Date: Jan. 18, 2007

(54) Interface to vehicle security and convenience systems

(76) Inventors: Patrick Allen, Sherbrocke (CA); Charles Petit, Ste-Catherine-de-Hatley (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/454,783

(22) Filed: Jun. 19, 2006

Related U.S. Application Data
(60) Provisional application No. 60/691,250, filed on Jun. 17, 2005.

(51) Int. Cl. G05D 1/00; G05D 3/00; G06F 17/00; G06F 7/00; G08C 19/12; H04L 17/02

(52) U.S. Cl. 701/2; 341/176

(57) ABSTRACT

An interface system to a vehicle data bus having a communication range greater than a communication range between an Original Equipment Manufacturer (OEM) transceiver and an OEM remote control device already integrated in a vehicle. The interface system comprises a remote control device, a control module transceiver and a control module. The range-extension of the system is performed by either having receivers with higher detection sensitivity or transmitters emitting signals at higher powers, or a combination of both. The interface system has a control module that can communicate with either one of, or both, the data bus and the function control module of the vehicle. Finally, the interface system also permits a bi-directional communication scheme between the remote control device and the control module transceiver.

### CROSS-REFERENCE TO RELATED APPLICATIONS

This application claims priority under 35USC§119(e) of U.S. provisional patent application 60/691,250, filed on Jun. 17, 2005 by Allen, the specification of which is hereby incorporated by reference.

### BACKGROUND OF THE INVENTION

1) Field of the Invention

The invention relates to the vehicle wireless convenience and security device industry.

2) Description of the Prior Art

Up until recently, the wireless (RF) control of vehicle functions has been limited to aftermarket products that made this possible. The extent of vehicle functions has also escalated from simple actions such as door locking and unlocking functionalities to starting the engine, opening the trunk and controlling panic modes buttons. Gradually, vehicle manufacturers have chosen to integrate certain vehicle functions as standard wireless control features within their product lines. Also, vehicles have evolved in terms of their control and communications architecture.

Whereas every function or feedback in a vehicle required a physical connection, common or parallel applications required parallel sets of harnesses in order to achieve their functional objectives. This practice was inefficient, expensive and difficult to troubleshoot. Modern methods now permit the concept of communications data buses to be integrated inside vehicles. Commands can thus be initially launched onto the data bus and then collected by the appropriate device for execution of a particular function. Certain types of vehicles are also equipped with functional control modules dedicated to controlling specific vehicle functions. A factory installed, or Original Equipment Manufacturer (OEM) remote control device can therefore be used to transmit commands to the OEM receiver/antenna, or transceiver, which sends them to the FCM for input onto the data bus and execution by the appropriate vehicle functional device.

One shortcoming of such OEM vehicle integrated systems is that the effective RF distance range of these factory systems is rather short under the best of circumstances. Another important drawback is the limited number of functions addressable by the OEM remote control device, while a much wider range of functions may be executable by the vehicle itself.

There is hence a growing consumer demand for systems that are capable of providing an interface with the factory installed vehicle devices (e.g., security and others). Furthermore, these interface systems nowadays usually require a rather complex installation process such that all the electrical connections must be considered; themselves often depending on the type of vehicle available in the marketplace. A need therefore exists for providing enhanced interface systems to vehicle security and convenience systems.

### SUMMARY OF THE INVENTION

According to an embodiment of the invention, there is provided an interface system for at least partial installation in a vehicle having a data bus, the interface system operating over a greater communication distance than a communication distance between an Original Equipment Manufacturer (OEM) transceiver and an OEM remote control device; the OEM transceiver being integrated in the vehicle and the interface system comprising: (1) a remote control device comprising at least one of: a transmitter for transmitting command signals, the transmitter emitting command signals at a greater power and hence having a capability of transmitting command signals over a greater distance than a transmission and distance capability of an OEM remote control device, and a receiver for receiving feedback signals, the receiver having a greater sensitivity and hence having a capability of receiving feedback signals over a greater distance than a reception and distance capability of an OEM remote control device; (2) a control module transceiver comprising at least one of: a transmitter for transmitting feedback signals and a receiver for receiving command signals; and finally, (3) a control module for communicating at least one of command and feedback signals between the control module transceiver and the vehicle data bus.

According to another embodiment of the invention, there is provided an interface system for at least partial installation in a vehicle having a data bus, the interface system operating over a greater communication distance than a communication distance between an Original Equipment Manufacturer (OEM) transceiver and an OEM remote control device, the OEM transceiver being integrated in the vehicle and the interface system comprising: (1) a remote control device comprising at least one of: a transmitter for transmitting command signals and a receiver for receiving feedback signals; (2) a control module transceiver comprising at least one of: a transmitter for transmitting feedback signals, the transmitter emitting the feedback signals at a greater power and hence having a capability of transmitting the feedback signals over a greater distance than a transmission and distance capability of an OEM transceiver; and a receiver for receiving command signals, the receiver having a greater sensitivity and hence having a capability of receiving the command signals over a greater distance than a reception and distance capability of an OEM transceiver; and finally, (3) a control module for communicating at least one of command signals and feedback signals between the control module transceiver and the data bus.

According to yet another embodiment of the invention, there is provided a method for interfacing to a data bus installed in a vehicle, the interfacing method enabling a communication over a greater distance than a communication distance between an Original Equipment Manufacturer (OEM) transceiver and an OEM remote control device, the OEM transceiver being integrated in said vehicle and the interfacing method comprising (1) providing a remote control device comprising for performing at least one of: transmitting command signals at a greater power and hence transmitting the command signals over a greater distance than a transmission and distance capability of an OEM remote control device; and receiving feedback signals with a greater sensitivity and hence receiving these feedback signals over a greater distance than a reception and distance capability of an OEM remote control device; (2) providing a control module transceiver comprising for performing at least one of: transmitting feedback signals and receiving command signals; and finally, (3) providing a control module for communicating at least one of command signals and feedback signals between the control module transceiver and the data bus.

According to yet another embodiment of the invention, there is provided a method for interfacing to a data bus installed in a vehicle, the interfacing method enabling a communication over a greater distance than a communication distance between an Original Equipment Manufacturer (OEM) transceiver and an OEM remote control device, the OEM transceiver being integrated in said vehicle and the interfacing method comprising: (1) providing a remote control device comprising for performing at least one of: transmitting command signals and receiving feedback signals; (2) providing a control module transceiver comprising for performing at least one of: transmitting feedback signals at a greater power and hence transmitting said feedback signals over a greater distance than a transmission and distance capability of said OEM transceiver; and receiving command signals with a greater sensitivity and hence receiving said command signals over a greater distance than a reception and distance capability of said OEM transceiver; and finally (3), providing a control module for communicating at least one of said command signals and said feedback signals between said control module transceiver and said data bus.

According to yet another embodiment of the invention, there is provided an interface system for at least partial installation in a vehicle having a data bus, the interface system operating over a greater communication distance than a communication distance between an Original Equipment Manufacturer (OEM) transceiver and an OEM remote control device, the OEM transceiver being integrated in the vehicle, the interface system comprising: a remote control device comprising at least one of: a transmitter for transmitting command signals; and a receiver for receiving feedback signals; a control module transceiver comprising at least one of: a transmitter for transmitting feedback signals; a processor for providing control module transceiver signals which emulate the OEM transceiver signals corresponding to known vehicle functions or commands to be decoded by the IFCM and a receiver for receiving command signals; and a control module for communicating at least one of the command signals and the feedback signals between the control module transceiver and the data bus; wherein said greater communication distance being the result of at least one of: transmitting signals at a power level on a communication link between said remote control device and said control module transceiver that is greater than a power level between said OEM transceiver and said OEM remote control device; receiving signals with a sensitivity level of at least one of remote control device receiver and control module transceiver receiver that is greater that a sensitivity level of at least one of said OEM transceiver and said OEM remote control device; transmitting signals on said communication link with a data rate on link between remote control device and control module transceiver that is lower than a data rate between said OEM transceiver and said OEM remote control device.

### BRIEF DESCRIPTION OF THE DRAWINGS

Further features and advantages of the present invention will become apparent from the following detailed description, taken in combination with the appended drawings, in which:

FIG. 1 is a block diagram showing an interface system and its environment according to an embodiment of the invention.

FIG. 2 is a block diagram showing the interfacing method used by the interface system in its environment according to another embodiment of the invention.

It will be noted that throughout the appended drawings, like features are identified by like reference numerals.

### DETAILED DESCRIPTION OF THE INVENTION

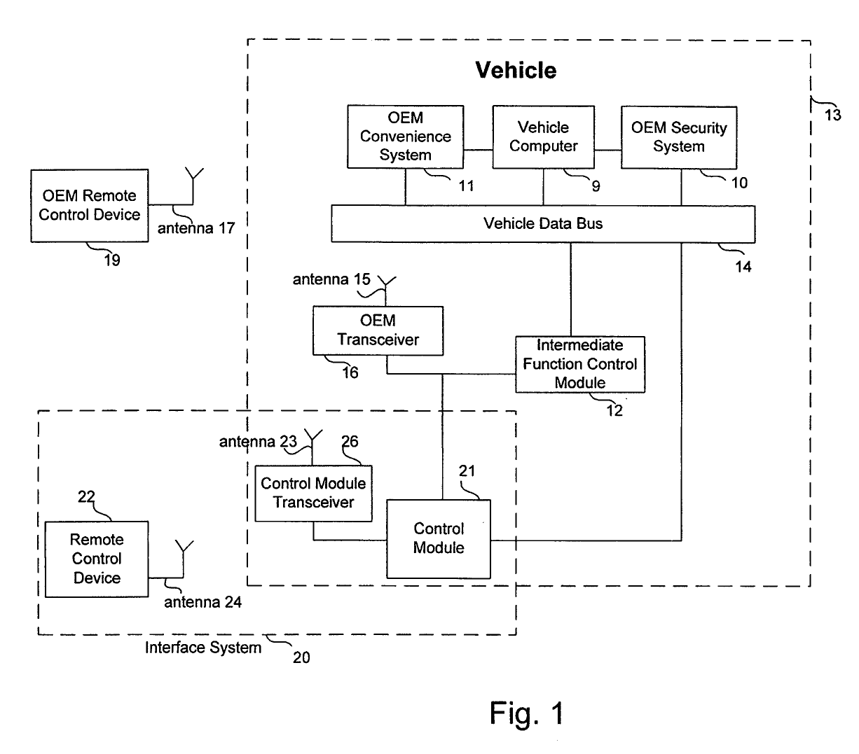

Referring to FIG. 1, vehicle 8 is shown, equipped with factory installed security systems such as OEM Security System 10, OEM Convenience System 11, and Vehicle Computer 9). Many vehicles are now also equipped with a functional control module (FCM), referred to herein as an Intermediate Function Control Module (IFCM) 12, which is connected to the Vehicle Data Bus 14. The IFCM 12 may also be interpreted as a Body Control Module (BCM). Finally, vehicles are also often equipped with a factory installed OEM transceiver 16, equipped with an OEM receiver and transmitter (not shown) and an antenna referred to herein as antenna 15. OEM Transceiver 16 can communicate with an IFCM 12 and with an OEM keyless or Remote Control Device 19 (also equipped with a transmitter and receiver (not shown) and with an illustrated antenna 17). The IFCM 12 generally exercises the control over vehicle functions such as door locks, sliding doors, factory installed alarms and the like via the Vehicle Data Bus 14.

The Interface System 20 thus provides vehicles equipped with an FCM, now referred to as an IFCM 12, the capability of interfacing with such an IFCM 12 and/or a Vehicle Data Bus 14. More specifically, the Interface System 20 is meant to provide this capability by using a Remote Control Device 22, a Control Module 21 with a Control Module Transceiver 26, this transceiver comprising its own receiver, transmitter (not shown), and antenna 23. Similarly, the Remote Control Device 22 is also equipped with a receiver and transmitter (not shown), as well as an antenna 24. Both the Remote Control Device 22 and the Control Module Transceiver 26 are designed such that their receiver offers greater reception sensitivity and their transmitter emits signals with a greater power, thereby providing the Interface System 20 with for a much greater communication distance than the distance offered by OEM systems. For example, for one embodiment of the invention where the environment is an open field, and in which a communication between the Remote Control Device 22 and the Control Module Transceiver 26 is performed in the Radio-Frequency (RF) range, at either 372.5 MHz or 433.92 MHz, the communication distance is between 1000 to 2000 feet. Communication distance is usually determined by the receiver sensitivity, itself dependent on the intrinsic receiver sensitivity, the type of antenna used, the data rate, the location of the antenna within the Vehicle 8, and the physical environment enclosed within the communication range (trees, buildings and RF interferences for example). Again as an example, and in one embodiment of the invention, it is measured that the Remote Control Device 22 has a receiver sensitivity of −112 dBm while it can also emit signals at powers in the order of 8 to 15 dBm (without any connection to an antenna 24 and provided there is a 50 Ohms load), and that the Control Module Transceiver 26 has a receiver sensitivity between −100 to −112 dBm while it can also emit signals at powers in the order of 8 to 15 dBm (without any connection to an antenna 23 and provided there is a 50 Ohms load). It can be approximated, however, that when keeping the data rate, the environmental factors and the antenna gains constant, the communication distance of the interface system doubles for every 6 dB increase in either receiver sensitivity or transmitter output signal powers. As a comparison, the communication between OEM Remote Control Device 19 and OEM Transceiver 16 in an open field environment, performed at a frequency of 315 MHz is limited to approximately 200 feet.

A Control Module 21 is connected to its Control Module Transceiver 26, and installed in a vehicle equipped with an FCM, the latter now referred to as an IFCM 12. The Control Module 21 connects directly to the link between the IFCM 12 and its OEM Transceiver 16, while also offering the possibility of being connected directly with the Vehicle Data Bus 14.

Hence, a user of the Remote Control Device 22 controls all the functions that can be initiated by the IFCM 12. For example, the user sends a command signal via the Remote Control Device 22. Such command signals may be to open or close the selected door(s), start the engine, set the alarm, or any other function supported by the vehicle. The command signal is received and detected by the Control Module Transceiver 26, which forwards the converted electrical signal for interpretation by the Control Module 21. From this received signal, the Control Module 21 sends a signal emulating the command signal that would usually come from the OEM transceiver 16 to the IFCM 12. The IFCM 12 can then detect and decode this signal to generate the appropriate code function onto the Vehicle Data Bus 14. Alternatively, the Control Module 21 may by-pass the IFCM 12 and communicate directly with the Vehicle Data Bus 14. Once the appropriate code function is on the Vehicle Data Bus 14, the intended functional device, either the Vehicle Computer 9, the OEM Security System 10, or the OEM Convenience System 11, is able to perform the required action.

The general configuration requires that the Control Module 21 emulates the signals usually provided by the OEM Transceiver 16. These signals correspond to already known vehicle functions or commands that are to be received and decoded by the IFCM 12. The Control Module 21 is hence equally capable of channeling the appropriately emulated convenience and security command signals to the IFCM 12 as if it came from the OEM Transceiver 16, and placing or inputting the appropriate code function onto the Vehicle Data Bus 14. Once this task is performed, the appropriate functional device of the Vehicle 8, OEM Security System 10, OEM Convenience System 11 and Vehicle Computer 9 for example, can then execute accordingly.

Also, unlike the known state of the art, wherein there is a limited number of possible functions addressable by the OEM Remote Control Device 19 or any other keyless remote control device, the Remote Control Device 22 described herein can harbor functions not available with the OEM Transceiver 16 and the OEM Remote Control Device 19, and yet supported or supportable by the vehicle 8.

The Interface System 20 can also serve as an interface system between an after-market remote control system and the vehicle's IFCM 12 and the Vehicle Data Bus 14, thereby increasing the after-market remote control's communication distance by using its own enlarged communication distance capability. The Interface System 20 also simplifies the installation process of any after-market remote control system since only one single connection is required with the described Interface System 20, in the case where the after-market remote control system is connected before the IFCM. As an example, an after-market remote control system can add functionalities not originally supported by the vehicle and its OEM system such as shock sensors, automatic defrost functions, or provide for a remote starting system as well.

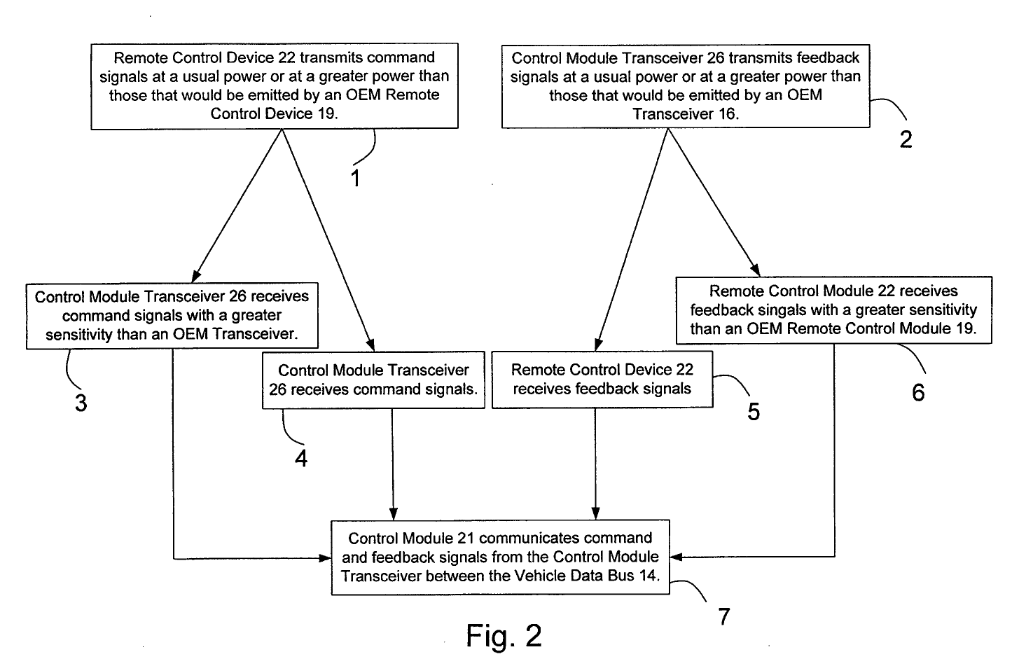

Now referring to FIG. 2, the interfacing method used by the system to increase the communication distance relies on a series of steps. First, in steps 1 and 2, the transmission of command signals from the Remote Control Device 22, and the transmission of feedback signals from the Control Module Transceiver 26 are performed. These are either emitted at a usual power equivalent to the powers that would be generated by the OEM Transceiver 16 and the OEM Remote Control Device 19. Then, steps 3 to 6 are the different combinations that may be possible. In step 3, the transmitted command signals are received by the Control Module Transceiver 26 with a greater sensitivity than an OEM Transceiver, while this is not the case in step 4. Similarly, in step 6, the emitted feedback signals are received by the Remote Control Module 22 with a greater sensitivity than an OEM Remote Control Device 19. These combinations therefore permit that the system operates at a greater communication distance than the OEM system comprising an OEM Transceiver 16 and an OEM Remote Control Device 19. Finally, in step 7, the Control Module 21 communicates the command or feedback signals from the Control Module Transceiver 26 to the Vehicle Data Bus 14.

Finally, referring to the interface system and the interfacing method described in FIGS. 1 and 2, both the Control Module Transceiver 26 and the Remote Control Device 22 can communicate in a bi-directional fashion. This is possible since the Control Module 21 comprises means for channeling commands to the IFCM 12 and to generate convenience commands on the Vehicle Data Bus 14. The Control Module 21 also has the means for returning feedback signals to the Remote Control Device 22. Such feedback signals can result from the vehicle's security status changes for example, in which case they are issued from the IFCM 12. Hence, the Control Module 21 can use the Control Module Transceiver 26 for acknowledging the reception of a command back to the Remote Control Device 22 using feedback signals. Alternatively, the Control Module 21 can use the Control Module Transceiver 26 for echoing the communication between the Vehicle Data Bus 14 and the IFCM 12 back to the Remote Control Device 22, again using feedback signals. This bi-directional communication thus permits the production of feedback signals, these possibly indicating the reception of a command, the decoding of an acknowledgement signal, or a change in the vehicle's security status through the detection of intrusion or tampering of the vehicle, the activation or deactivation of an alarm, as well as a “Panic Mode” set by either the Remote Control Device 22 or the OEM Remote Control Device 19 for example. Therefore, the feedback signals are used for at least one of receiving a command and decoding an acknowledgement signal, detecting vehicle tamper conditions, detecting vehicle alarm conditions, and detecting the setting of a “Panic Mode” by one of both Remote Control Devices 22 and 19.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

The embodiments of the invention described above are intended to be exemplary only. The scope of the invention is therefore intended to be limited solely by the scope of the appended claims.

What is claimed is:

1. An interface system for at least partial installation in a vehicle having a data bus, said interface system operating over a greater communication distance than a communication distance between an Original Equipment Manufacturer (OEM) transceiver and an OEM remote control device, said OEM transceiver being integrated in said vehicle, said interface system comprising:
a remote control device comprising at least one of:
a transmitter for transmitting command signals, the transmitter emitting said command signals at a greater power and hence having a capability of transmitting said command signals over a greater distance than a transmission and distance capability of said OEM remote control device; and
a receiver for receiving feedback signals, the receiver having a greater sensitivity and hence having a capability of receiving said feedback signals over a greater distance than a reception and distance capability of said OEM remote control device;
a control module transceiver comprising at least one of:
a transmitter for transmitting feedback signals; and
a receiver for receiving command signals; and
a control module for communicating at least one of said command signals and said feedback signals between said control module transceiver and said data bus.

2. The interface system as described in claim 1, wherein said control module transceiver further comprises at least one of:
a transmitter for transmitting feedback signals, the transmitter emitting said feedback signals at a greater power and hence having a capability of transmitting said feedback signals over a greater distance than a transmission and distance capability of said OEM transceiver; and
a receiver for receiving command signals, the receiver having a greater sensitivity and hence having a capability of receiving said command signals over a greater distance than a reception and distance capability of said OEM transceiver.

3. The interface system of claim 2, wherein said vehicle further comprises an Intermediate Function Control Module (IFCM), further wherein said control module is for connecting to said at least one of said IFCM and said data bus.

4. The interface system of claim 3, wherein said IFCM comprises a Body Control Module (BCM).

5. The interface system as described in claim 3, further wherein said control module is also for emulating said OEM transceiver signals corresponding to known vehicle functions or commands to be decoded by said IFCM.

6. The interface system as described in claim 3, wherein said control module is also for connecting with an after-market remote starter system via a single connection located before the IFCM.

7. The interface system as described in claim 6, further wherein said interface system provides for a longer distance range than the after-market remote starter system.

8. The interface system as described in claim 3, wherein said remote control device is also for controlling functions not available with said OEM remote control device and said OEM transceiver, yet supported by the vehicle.

9. The interface system as described in claim 3, wherein said control module further comprises at least one of:
means for channeling commands to said IFCM;
means for generating convenience commands on said data bus;
means for returning feedback signals from said control module to said remote control device; and
means for returning feedback signals resulting from vehicle's security status changes and issued from said IFCM to said remote control device.

10. The interface system as described in claim 3, wherein said control module transceiver and said remote control device also further comprise means for communicating in a bi-directional fashion.

11. An interface system for at least partial installation in a vehicle having a data bus, said interface system operating over a greater communication distance than a communication distance between an Original Equipment Manufacturer (OEM) transceiver and an OEM remote control device, said OEM transceiver being integrated in said vehicle, said interface system comprising:
a remote control device comprising at least one of:
a transmitter for transmitting command signals; and
a receiver for receiving feedback signals;
a control module transceiver comprising at least one of:
a transmitter for transmitting feedback signals, the transmitter emitting said feedback signals at a greater power and hence having a capability of transmitting said feedback signals over a greater distance than a transmission and distance capability of said OEM transceiver; and
a receiver for receiving command signals, the receiver having a greater sensitivity and hence having a capability of receiving said command signals over a greater distance than a reception and distance capability of said OEM transceiver; and
a control module for communicating at least one of said command signals and said feedback signals between said control module transceiver and said data bus.

12. The interface system as described in claim 11, wherein said remote control device further comprises at least one of:
a transmitter for transmitting command signals, the transmitter emitting said command signals at a greater power and hence having a capability of transmitting said command signals over a greater distance than a transmission and distance capability of said OEM remote control device; and
a receiver for receiving feedback signals, the receiver having a greater sensitivity and hence having a capability of receiving said feedback signals over a greater distance than a reception and distance capability of said OEM remote control device.

13. The interface system of claim 12, wherein said vehicle further comprises an Intermediate Function Control Module (IFCM), further wherein said control module is for connecting to said at least one of said IFCM and said data bus.

14. The interface system of claim 13, wherein said IFCM comprises a Body Control Module (BCM).

15. The interface system as described in claim 13, further wherein said control module is also for emulating said OEM transceiver signals corresponding to known vehicle functions or commands to be decoded by said IFCM.

16. The interface system as described in claim 13, wherein said control module is also for connecting with an after-market remote starter system via a single connection located before the IFCM.

17. The interface system as described in claim 16, further wherein said interface system provides for a longer distance range than the after-market remote starter system.

18. The interface system as described in claim 13, wherein said remote control device is also for controlling functions not available with said OEM remote control device and said OEM transceiver, yet supported by the vehicle.

20. The interface system as described in claim 16, wherein said control module further comprises at least one of:
means for channeling commands to said IFCM;
means for generating convenience commands on said data bus;
means for returning feedback signals from said control module to said remote control device; and
means for returning feedback signals resulting from vehicle's security status changes and issued from said IFCM to said remote control device.

21. The interface system as described in claim 13, wherein said control module transceiver and said remote control device also further comprise means for communicating in a bi-directional fashion.

22. A method for interfacing to a data bus in a vehicle, said interfacing method enabling a communication over a greater distance than a communication distance between an Original Equipment Manufacturer (OEM) transceiver and an OEM remote control device, said OEM transceiver being integrated in said vehicle, said interfacing method comprising:
providing a remote control device comprising for performing at least one of:
transmitting command signals at a greater power and hence transmitting said command signals over a greater distance than a transmission and distance capability of said OEM remote control device; and
receiving feedback signals with a greater sensitivity and hence receiving said feedback signals over a greater distance than a reception and distance capability of said OEM remote control device;
providing a control module transceiver comprising for performing at least one of:
transmitting feedback signals; and
receiving command signals; and
providing a control module for communicating at least one of said command signals and said feedback signals between said control module transceiver and said data bus.

23. The interfacing method as described in claim 22, wherein said control module transceiver further comprises performing at least one of:
transmitting feedback signals at a greater power and hence transmitting said feedback signals over a greater distance than a transmission and distance capability of said OEM transceiver; and
receiving command signals with a greater sensitivity and hence receiving said command signals over a greater distance than a reception and distance capability of said OEM transceiver.

24. The interfacing method as described in claim 23, wherein said control module transceiver further comprising performing at least one of:
acknowledging the reception of a command back to said remote control device using feedback signals; and
echoing the communication between said data bus and said IFCM, back to said remote control device using feedback signals.

25. The interface method as described in claim 24, further wherein said feedback signals are used for at least one of:
receiving a command and decoding an acknowledgement signal;
detecting vehicle tamper conditions;
detecting vehicle alarm conditions; and
detecting at least one of said remote control device and said OEM remote control device set in “Panic Mode”.

26. A method for interfacing to a data bus in a vehicle, said interfacing method enabling a communication over a greater distance than a communication distance between an Original Equipment Manufacturer (OEM) transceiver and an OEM remote control device, said OEM transceiver being integrated in said vehicle, said interfacing method comprising:
providing a remote control device comprising for performing at least one of:
transmitting command signals; and
receiving feedback signals;
providing a control module transceiver comprising for performing at least one of:
transmitting feedback signals at a greater power and hence transmitting said feedback signals over a greater distance than a transmission and distance capability of said OEM transceiver; and
receiving command signals with a greater sensitivity and hence receiving said command signals over a greater distance than a reception and distance capability of said OEM transceiver; and
providing a control module for communicating at least one of said command signals and said feedback signals between said control module transceiver and said data bus.

27. The interfacing method as described in claim 26, wherein said remote control device further comprises performing at least one of:
transmitting command signals at a greater power and hence transmitting said command signals over a greater distance than a transmission and distance capability of said OEM remote control device; and
receiving feedback signals with a greater sensitivity and hence receiving said feedback signals over a greater distance than a reception and distance capability of said OEM remote control device.

28. The interfacing method as described in claim 27, wherein said control module transceiver further comprising performing at least one of:
acknowledging the reception of a command back to said remote control device; and
echoing the communication between said data bus and said IFCM, back to said remote control device.

29. The interface method as described in claim 28 wherein said feedback signals are used for at least one of:
receiving a command and decoding an acknowledgement signal;
detecting vehicle tamper conditions;
detecting vehicle alarm conditions; and
detecting at least one of said remote control device and said OEM remote control device set in “Panic Mode”.

30. An interface system for at least partial installation in a vehicle having a data bus, said interface system operating over a greater communication distance than a communication distance between an Original Equipment Manufacturer (OEM) transceiver and an OEM remote control device, said OEM transceiver being integrated in said vehicle, said interface system comprising:
a remote control device comprising at least one of:
a transmitter for transmitting command signals; and
a receiver for receiving feedback signals;
a control module transceiver comprising at least one of:
a transmitter for transmitting feedback signals;
a processor for providing control module transceiver signals which emulate said OEM transceiver signals corresponding to known vehicle functions or commands to be decoded by said IFCM and
a receiver for receiving command signals; and
a control module for communicating at least one of said command signals and said feedback signals between said control module transceiver and said data bus;
wherein said greater communication distance being the result of at least one of:
transmitting signals at a power level on a communication link between said remote control device and said control module transceiver that is greater than a power level between said OEM transceiver and said OEM remote control device;
receiving signals with a sensitivity level of at least one of remote control device receiver and control module transceiver receiver that is greater that a sensitivity level of at least one of said OEM transceiver and said OEM remote control device;
transmitting signals on said communication link with a data rate on link between remote control device and control module transceiver that is lower than a data rate between said OEM transceiver and said OEM remote control device.
